(19) United States
(12) Patent Application Publication
(10) Pub. No.: US 2016/0375604 A1
(43) Pub. Date: Dec. 29, 2016

(54) ADJUSTABLE TOOLREST FOR A LATHE

(71) Applicant: JMJ Tools LLC, Napa, CA (US)

(72) Inventor: Michael R. Forman, Los Gatos, CA (US)

(21) Appl. No.: 14/749,530

(22) Filed: Jun. 24, 2015

(51) Int. Cl. B27C 7/06

(52) U.S. Cl. CPC B27C 7/06

(57) ABSTRACT

Methods and systems for adjusting a toolrest of a lathe are disclosed herein. In one embodiment, a mechanism comprises a banjo holding a toolrest, the toolrest being coarsely adjusted to a first vertical position relative to the banjo; a toolrest adjustment knob allowing for the fine adjustment of a second vertical position of the toolrest relative to the banjo; and a banjo adjustment knob allowing for an adjustment to a horizontal position of the toolrest to a banjo.

### BACKGROUND

### Field of the Invention

The present invention relates generally to woodturning lathes, and more particularly to a mechanism that adjusts a toolrest to a lathe.

### SUMMARY

According to some embodiments, the present technology is directed to a mechanism for controllably adjusting with precision a toolrest of a woodturning lathe, the mechanism comprising: (a) a banjo mounted on a bed of a lathe, the banjo holding a toolrest; (b) a collar attached to a tool-post, the collar setting an initial coarse position of a height of the toolrest, the toolrest being coarsely adjusted to a first vertical position relative to the banjo; (c) a toolrest adjustment knob, the toolrest adjustment knob allowing for a fine adjustment of a second vertical position of the toolrest relative to the banjo; (d) a toolrest clamp located between the collar and the toolrest adjustment knob, the toolrest clamp locking the toolrest in a fixed rotational position; (e) a banjo adjustment knob, the banjo adjustment knob allowing for an adjustment to a second horizontal position of the toolrest to a banjo, the toolrest having been coarsely adjusted to a first horizontal position relative to the banjo; and (f) a banjo clamp locking the second horizontal position of the toolrest relative to the banjo.

According to various embodiments, the present technology is directed to a method, comprising: (a) resting a tool on the toolrest with a first hand, the toolrest supported by an adjustable support; and (b) turning a toolrest adjustment knob with a second hand until a tip of the tool is on a centerline of the lathe, after which the toolrest self-locks into a banjo.

According to example embodiments, the present technology is directed to a method, comprising: (a) with a first hand, resting a tool on a toolrest closely adjacent to a centerline of an object being turned; (b) with the first hand, positioning a tip of the tool on the toolrest closely adjacent to the centerline of the object being turned; and (c) with a second hand, turning the toolrest adjustment knob to either raise or lower the toolrest, turning the toolrest adjustment knob until the tip of the tool is at an optimum, pre-determined location proximate to a centerline of the lathe.

### BRIEF DESCRIPTION OF THE DRAWINGS

FIG. 1 is a perspective view of an exemplary adjustable toolrest for a lathe.

FIG. 2 is a cut-away view of a cross-section of an exemplary protective adjustable toolrest for a lathe.

FIG. 3 is a flowchart of an example method for adjusting a toolrest for a lathe.

FIG. 4 is a flowchart of a second example method for adjusting a toolrest for a lathe.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Woodturning is increasingly the activity of artisans. Artisans shape the object based on a number of factors. These factors include a pre-conceived rough design, the type of wood used, the grain direction in the wood, defects in the wood, and the texture and pattern of the grain and surface of the wood. As such, the final object is usually quite different from the pre-conceived rough design. The final shape of the object is determined in real time on a lathe. Artisan woodturning is different from metal working and conventional woodturning where the pre-conceived design is the final design. In this more conventional work, the object could be shaped by a computer numerical controlled (CNC) machine programmed with the final design.

Artisan woodturning relies on a tool manually held on a fulcrum in contrast to a tool being clamped into a holder that is moved by a hand wheel or motorized system. The fulcrum is a support for the tool and allows the tool to be manually moved into the work and for the tip of the tool to be adjusted at different angles relative to the work. The manual tip adjustment is necessary to cut and scrape the object efficiently and to follow the grain of the object.

A lathe is a machine tool which rotates a workpiece on its axis to perform various operations such as cutting, sanding, knurling, drilling or deformation, facing, turning, with tools that are applied to the workpiece to form an object with a specific shape. Lathes are used in woodturning, metalworking, metal spinning, thermal spraying, parts reclamation, and glass-working.

Lathes generally include a bed, which is typically a horizontal beam. At one end of the lathe is a headstock. The headstock contains high-precision spinning bearings. Rotating within the bearings is a horizontal axle, with an axis parallel to the bed, called a spindle. Spindles are often hollow, and have exterior threads and/or an interior Morse taper on the “inboard” end (i.e., facing to the right/towards the bed) by which work-holding accessories may be mounted to the spindle. Spindles are powered, and impart motion to the workpiece.

A woodturning lathe has a banjo, which is a flat piece that sits crosswise on the bed. The banjo provides controlled vertical movement of the toolrest. The banjo may also provide controlled movement at ninety degrees to a vertical plane for the toolrest. The position of the banjo can be adjusted by hand. Ascending vertically from the banjo is a tool-post, at the top of which is a toolrest. In woodturning, hand tools are braced against a toolrest and levered into the workpiece. A toolrest is an adjustable, horizontal bar adapted to a tool-post. The toolrest provides a fulcrum for a woodturning tool, in which the fulcrum is controlled and incremental. The toolrest also provides a single contact point for a woodturning tool.

The spindle may be driven by a belt or gear drive to a power source. In most modern lathes, this power source is an integral electric motor, often either in the headstock, to the left of the headstock, or beneath the headstock, concealed in the stand.

The counterpoint to the headstock is the tailstock, as it can be positioned at any convenient point on the bed by sliding it to the required area. A tailstock ram is a piston-like shaft that can be moved in and out of the tailstock by turning the tailstock handwheel.

A woodturner positions his/her tools on the centerline of the lathe. The centerline is an imaginary line extending from the center of the spindle through the center of the tailstock ram, representing the central axis of the lathe around which the work rotates. When turning objects on the lathe, such as vases, bowls, hollow forms and others, it is almost always necessary to change tools to get different effects and shapes on the object. For example, a woodturner might use a roughing gouge to make the initial shape, an Irish grind gouge to make the refined shape, a spindle gouge to smooth the surface, and finally, a scraper to get the final surface finish. Each tool tip has a different shape and thickness, requiring a reset of the height of the tool rest so that a particular tool is at or approximate the centerline of the lathe. Existing lathes require a woodturner to stop the lathe, put his/her tool down, hold the toolrest in position with one hand while releasing the lock on the toolrest with the other hand, reposition the toolrest for a new tool and/or new toolrest, lock the toolrest, ensure that the new tool is on the centerline, readjust if necessary, and finally, lock the toolrest relative to the banjo.

The claimed invention is an improvement over existing lathes, because it reduces the number of manual steps needed to reposition the height and/or horizontal position of the toolrest, allowing the woodturner to hold a tool on the toolrest, the toolrest supported by an adjustable support, with one hand and then turn an adjustment knob with the other hand until the tip of the tool is on or approximate the centerline. The toolrest self-locks into the banjo, so the woodturner does not need to lock the toolrest into the banjo.

In another embodiment, the claimed invention allows the woodturner to position the tip of the woodturning cutting tool to an optimum pre-determined location proximate to the centerline of the woodturning lathe. With one hand, the woodturner rests the woodturning cutting tool on a toolrest closely adjacent to the centerline of the object to be turned. With the other hand, the woodturner turns the adjustment knob that engages a gearing mechanism that raises and lowers the toolrest, turning the adjustment knob until the tip of the woodturning tool is at an optimum pre-determined location proximate to the centerline of the woodturning lathe.

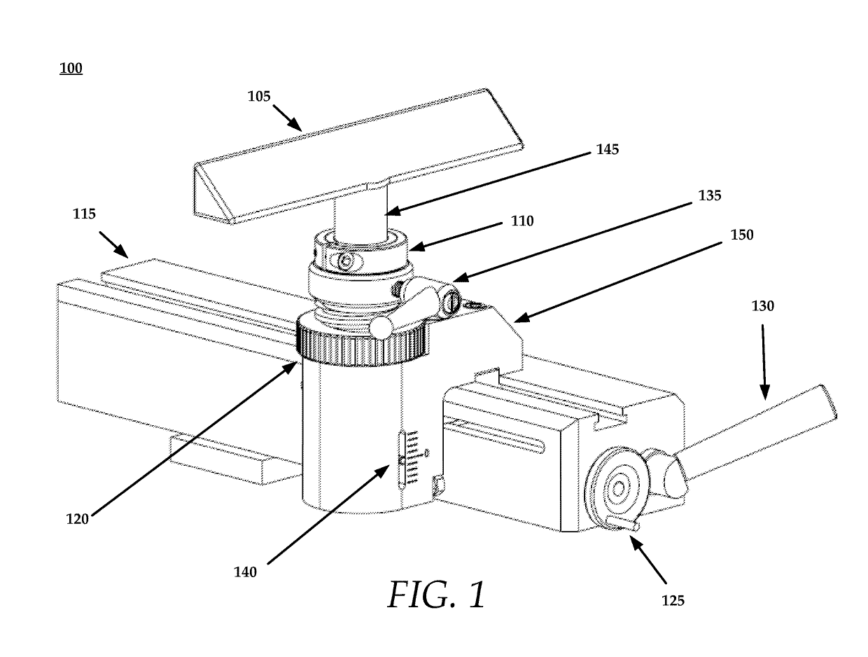

FIG. 1 is a perspective view of an exemplary adjustable toolrest 105 for a lathe 100. In the illustrated embodiment, a mechanism for adjusting a toolrest 105 for a lathe 100 includes a collar 110, a banjo 115, a toolrest adjustment knob 120, a banjo adjustment knob 125, a banjo clamp 130, a toolrest clamp 135, an indicator 140, a tool-post 145, and a carriage 150.

As shown in FIG. 1, the collar 110 encircles tool-post 145, and is located under toolrest 105. The tool-post 145 is received by a bore. The collar 110 is a simple, ring-like device that may set a vertical position of the toolrest 105 relative to the banjo 115. The collar 110 slides over or onto the tool-post 145. The vertical setting by collar 110 may be a coarse adjustment of the toolrest 105 relative to the banjo 115. As such, the collar 110 may be set to initially adjust the vertical position of the toolrest 105 relative to the banjo 115. This vertical position is held by a gear mechanism. The collar 110 establishes an initial position below the centerline of the lathe.

The vertical setting by collar 110 may be considered a “neutral” position, designated as “0”. Any adjustments from this neutral position may be indicated as a negative (−) value or a positive (+) value. This negative or positive value may be shown on indicator 140 on carriage 150, indicator 140 showing lines or various numbers marking any deviation from the neutral position. Indicator 140 on carriage 150 allows the woodturner to view the vertical position adjustment of the toolrest 105 being set by the collar 110, as well as the increments moved, up or down. Indicator 140 may be a gauge.

A fixed rotational position of the toolrest 105 may be locked in by the toolrest clamp 135 using a locking mechanism. The toolrest clamp 135 is located between the collar 110 and toolrest adjustment knob 120. Toolrest clamp 135 may be of either the horizontal or vertical variety. There may be multiple toolrest clamps, each toolrest clamp being either horizontal or vertical.

Continuing with FIG. 1, the toolrest adjustment knob 120 is turned to adjust the vertical position of the toolrest 105 relative to the banjo 115. The vertical position set by the toolrest adjustment knob 120 allows for a fine adjustment of the toolrest 105 relative to the banjo 115. Turning of the toolrest adjustment knob 120 engages a gearing mechanism that raises and lowers the toolrest. In contrast to collar 110, the toolrest adjustment knob 120 finely adjusts the position of toolrest 105. This particular adjustment “fine tunes” the toolrest 105 to an exact location, and moves the toolrest 105 with respect to the banjo 115 in very small increments (e.g., increments of one-sixteenth of an inch). The toolrest adjustment knob 120 is located on carriage 150.

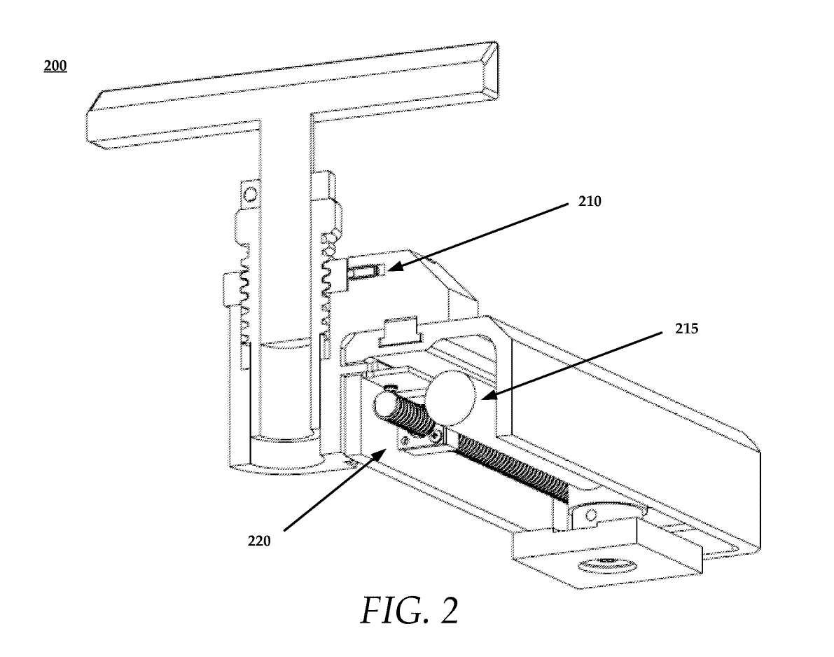

FIG. 2 is a cut-away view of a cross-section of an exemplary protective adjustable toolrest for a lathe. In the featured embodiment, a ball detent 210 is located inside carriage 150. This ball detent 210 creates a tactile sound (e.g., clicking) when the toolrest adjustment knob 120 is turned. As discussed, the toolrest adjustment knob 120 may be moved in very small increments. As such, the ball detent 210 may create the tactile sound each time the toolrest adjustment knob 120 is moved up or down an increment by the woodturner.

Referring back to FIG. 1, the banjo adjustable knob 125 is turned to adjust the horizontal position of the toolrest 105 with respect to the banjo 115. The desired horizontal position is held by a gear mechanism. Banjo clamp 130 allows for the locking of the banjo 115 to the bed of lathe 100. In FIG. 2, acme screw and nut 220, located in the banjo 115, drive the horizontal adjustment. The engagement of the thread of the acme screw promotes sufficient holding force. An eccentric shaft 215 locks the banjo 115 to the lathe 100.

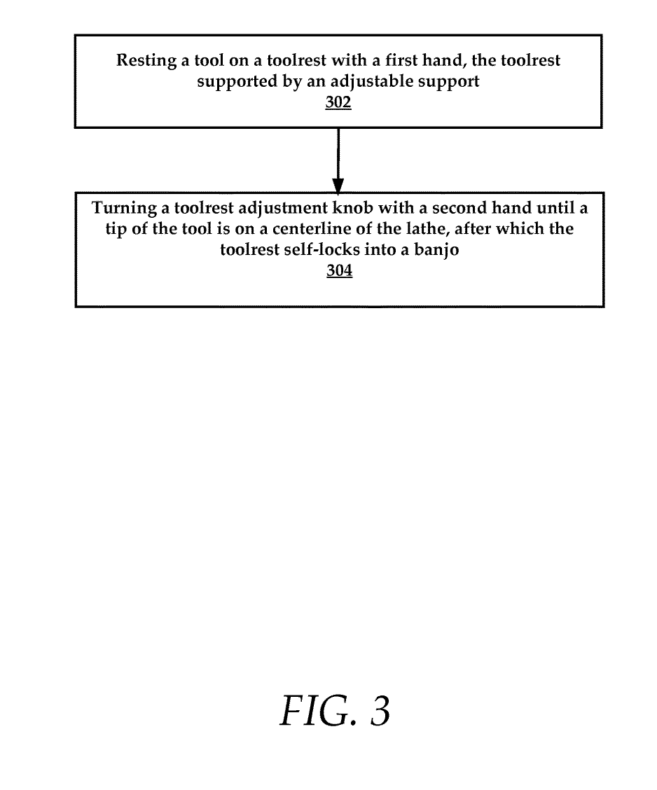

FIG. 3 is a flowchart of an example method for adjusting with precision a toolrest to a lathe. The method begins with the user (woodturner) resting 302 a tool on the toolrest with a first hand, the toolrest supported by an adjustable support. The method then includes the user turning 304 a toolrest adjustment knob with a second hand until a tip of the tool is on a centerline of the lathe, after which the toolrest self-locks into a banjo.

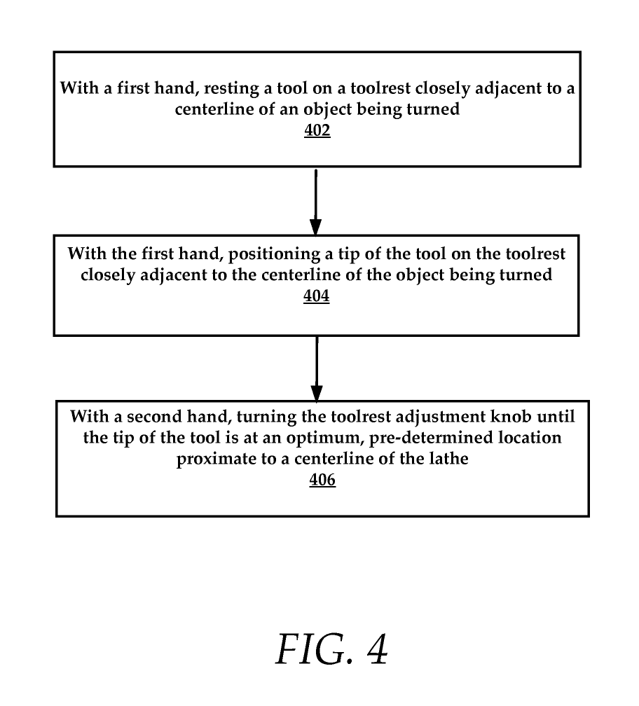

FIG. 4 is a flowchart of another example method for adjusting a toolrest to a lathe. The method begins with the user (woodturner) resting 402, with a first hand, a tool on a toolrest closely adjacent to a centerline of an object being turned. With this first hand, the user then positions 404 a tip of the tool on the toolrest closely adjacent to the centerline of the object being turned. With a second hand, the user 406 turns the toolrest adjustment knob to either raise or lower the toolrest, turning the toolrest adjustment knob until the tip of the tool is at an optimum, pre-determined location proximate to a centerline of the lathe.

While the present invention is disclosed by reference to the preferred embodiments and examples detailed above, it is to be understood that these examples are intended in an illustrative rather than a limiting sense. It is contemplated that modifications and combinations will readily occur to those skilled in the art, which modifications and combinations will be within the spirit of the invention and the scope of the following claims.

What is claimed is:

1. A mechanism for adjusting a toolrest of a lathe, the mechanism comprising:
a banjo mounted on a bed of a lathe, the banjo holding a toolrest, the toolrest being coarsely adjusted to a first vertical position relative to the banjo;
a toolrest adjustment knob, the toolrest adjustment knob allowing for a fine adjustment of a second vertical position of the toolrest relative to the banjo; and
a banjo adjustment knob, the banjo adjustment knob allowing for an adjustment to a horizontal position of the toolrest relative to the banjo, the toolrest having been coarsely adjusted to a first horizontal position relative to the banjo.

2. The mechanism for adjusting a toolrest of a lathe in claim 1, the mechanism including a collar attached to a tool-post, the collar setting an initial coarse position of a height of the toolrest.

3. The mechanism for adjusting a toolrest of a lathe in claim 2, the mechanism including a toolrest clamp located between the collar and the toolrest adjustment knob, the toolrest clamp locking the toolrest in a fixed rotational position.

4. The mechanism for adjusting a toolrest of a lathe in claim 1, the mechanism including a banjo clamp locking the banjo to a bed of the lathe.

5. The mechanism for adjusting a toolrest of a lathe in claim 4, in which the banjo clamp is located adjacent to the banjo adjustment knob.

6. The mechanism for adjusting a toolrest of a lathe in claim 1, in which the first vertical position is a neutral position.

7. The mechanism for adjusting a toolrest of a lathe in claim 6, in which the neutral position is marked “0” by an indicator.

8. The mechanism for adjusting a toolrest of a lathe in claim 6, in which a raised adjustment from the neutral position is marked as “+” and a lowered adjustment from the neutral position is marked as “−” on an indicator.

9. The mechanism for adjusting a toolrest of a lathe in claim 2, in which the collar provides an initial starting point below a centerline of the lathe.

10. A method for adjusting a toolrest of a lathe, the method comprising:
resting a tool on the toolrest with a first hand, the toolrest supported by an adjustable support; and
turning a toolrest adjustment knob with a second hand until a tip of the tool is on a centerline of the lathe, after which the toolrest self-locks into a banjo.

11. A method for adjusting a toolrest of a lathe, the method comprising:
with a first hand, resting a tool on a toolrest closely adjacent to a centerline of an object being turned;
with the first hand, positioning a tip of the tool on the toolrest closely adjacent to the centerline of the object being turned; and
with a second hand, turning the toolrest adjustment knob to either raise or lower the toolrest, turning the toolrest adjustment knob until the tip of the tool is at an optimum, pre-determined location proximate to a centerline of the lathe.
